(19) United States
(12) Patent Application Publication
(10) Pub. No.: US 2009/0113965 A1
(43) Pub. Date: May 7, 2009

(54) IMPROVED LOCKING APPARATUS

(76) Inventor: Yoav Weinberger, Haifa (IL)

Correspondence Address: Pearl Cohen Zedek Latzer, LLP, 1500 Broadway, 12th Floor, New York, NY, 10036, US

(21) Appl. No.: 11/885,270

(22) PCT Filed: Feb. 21, 2006
(86) PCT No.: PCT/IL06/00217

§ 371 Date: Sep. 16, 2008

(30) Foreign Application Priority Data
Mar. 1, 2005 (IL) 167196

(51) Int. Cl. E05B 27/00

(52) U.S. Cl. 70/493

(57) ABSTRACT

A lock and a cooperating key combination is disclosed, the lock comprising a stator and a rotor with a keyway, the key comprising a penetrating portion for insertion in the keyway. The penetrating portion includes at least on combination surface and at least one movable element that can be extended beyond at least one surface of the key, adding height to the surface of the key and for cooperation with at least one first control element for controlling rotation of the rotor. At least one second control element for controlling the rotation of the rotor is provided in the lock opposite the first control element with the keyway in between, the second control element adapted to cooperate with an aperture located on the opposite surface of the key, behind the movable element.

### FIELD OF THE INVENTION

The present invention generally relates to locking apparatus and more particularly to a key and lock actuated thereby, including means for adding height to the surface of the key shaft and other means for improving their security.

### BACKGROUND OF THE INVENTION

A great variety of keys and associated locks are known. A lock generally comprises a rotor embedded in a stator and operated by a key. The rotor is prevented from rotating by one or more pins located inside the stator and intruding into the rotor. When the key is inserted in the keyway, its unique predetermined topography moves the pins in order to facilitate the rotation of the rotor. Only a matching key can operate the lock, as other keys with different topography cannot properly align the pins and therefore cannot facilitate operation of the lock.

For many years the topography of keys was limited by the maximal height of the key blank. Practically the key combinations comprised dents (depressions) in the key blank.

However, keys with elevating elements were introduced too, to facilitate key combinations which also include elevated surfaces above the height of the key blank. See, for example, FR 2,161,204 (Vachette), WO0022263 (Donatini), WO 00/57006 (Weinberger), GB 2,161,204 (Valdajos), U.S. Pat. No. 5,839,308 (Eizen). These examples of prior art illustrate technology that involves introducing key surface elevations beyond the general key blank surface, so that it becomes possible to employ pin assemblies that are shorter that the length between the key blank maximal height and the perimeter of the rotor.

The ways in which additional elevation to the key blank surface at predetermined points was achieved included: providing a floating element in the key blank that is pushed out by a spring-activated pusher pin planted in the lock's rotor (U.S. Pat. No. 5,839,308), or by providing a spring-activated movable pin implanted in the key blank (for example FR 2,161,204), or by providing a resilient element made from elastic materials, that is placed inside a bore in the key blank and protrudes outside the key blank (WO 00/57006). Other methods of providing additional heights are known.

All above-mentioned examples of keys and associated locks use the protruded elevation of the key to operate lock control mechanisms. Yet they utilize only the protruding side of the moveable elements in the key for actuation of the control system of the rotation of the rotor.

The operating principle employed in the above-mentioned examples has a major vulnerability in that the disclosed locks can be opened by other keys having means for adjusting the height of the surface of the key shaft. In other words any key that provides the required added height at the required point on the surface of the key shaft can successfully operate the associated pins of these locks.

Increasingly keys are being invented to add height at predetermined points on a key shaft and consequently more and more such keys are available for opening locks built according to the principles of the above mentioned locks. The result is a loss of control over copying of keys built according to these principles bringing about a serious breach of security in the corresponding locks. Control over copying of keys is greatly enhanced when the keys are protected by a patent or other intellectual property laws that prevent unauthorized manufacture of substitute keys. From the moment that it is possible to manufacture keys with added height at predetermined points on the key shaft using methods not covered by a patent, the locks are dealt a fatal loss of security.

Therefore it is a main object of the current invention to provide an improved locking apparatus that facilitates the rotation of a lock's rotor by using not only the protruding section of a protruding element from the key blank, but also employing the opposite withdrawing side of the element or utilizing the void created under the protruding element when it protrudes outside the key, for operating additional control elements within the rotor.

U.S. Pat. No. 5,839,308, “LOCKING APPARATUS”, by Eizen et al. is based on the principle of adding height at one or more predetermined points on the surface of a key shaft by means of a movable pin element retained within the key shaft, the movable pin element being displaceable perpendicularly relative to the key shaft surface. When the key is located in its proper location in a cylinder comprising a plug in a housing, the movable pin element is displaced above the surface of the key shaft by spring-actuated movement of a pusher pin assembly located in the plug. The displaced pin element pushes on a first pin assembly located in the plug. The first pin assembly in turn pushes on a coaxially aligned second pin assembly located in the lock cylinder housing. The first and second pin assemblies are arranged such that the result of their movement is that a shear line between the plug and housing is thus defined by facing surfaces of the respective first and second pin assemblies, thereby permitting rotation of the plug in the housing.

The present invention suggests, inter alia improvements to Eizen's locking apparatus.

Another object of the present invention is the provision of such locking apparatus that makes it harder to use substitute keys to open locks built according to the principles of the current invention.

It is another main object of the current invention to provide such an improved locking apparatus with enhanced security features.

It is another main object of the current invention to provide such an improved locking apparatus with more possible key combinations.

It is another main object of the current invention to provide such an improved locking apparatus where the key and lock can be manufactured without requiring expensive or significant adaptation of existing manufacturing equipment and processes for similar existing such locking apparatuses.

Other objects and advantages of the present invention will become apparent after reading the present specification and reviewing the accompanying drawings.

### BRIEF DESCRIPTION OF THE INVENTION

There is thus provided, in accordance with some preferred embodiments of the present invention, a lock and a cooperating key combination, the lock comprising a stator and a rotor with a keyway, the key comprising a penetrating portion for insertion in the keyway, the penetrating portion including at least one combination surface and at least one movable element that can be extended beyond at least one surface of the key, adding height to said at least one surface of the key and for cooperation with at least one first control element for controlling rotation of the rotor,

wherein at least one second control element for controlling the rotation of the rotor is provided in the lock opposite said at least one first control element with the keyway in between, said at least one second control element adapted to cooperate with an aperture located on the opposite surface of the key, behind the movable element.

Furthermore, in accordance with some preferred embodiments of the present invention, said at least one second control element cooperates with the movable element when the key is inserted in the keyway.

Furthermore, in accordance with some preferred embodiments of the present invention, said at least one second control element operates the movable element when the key is inserted in the keyway.

Furthermore, in accordance with some preferred embodiments of the present invention, there is provided a lock for cooperation with a key comprising a penetrating portion for insertion in keyway of the lock, the penetrating portion including at least one combination surface and at least one movable element that can be extended beyond at least one surface of the key, adding height to the said at least one surface of the key and for cooperation with at least one first control element for controlling rotation of the rotor, the lock comprising:

a stator and a rotor with a keyway, wherein at least one second control element for controlling the rotation of the rotor is provided in the lock opposite said at least one first control element with the keyway in between, said at least one second control element adapted to cooperate with an aperture located on the opposite surface of the key, behind the movable element.

Furthermore, in accordance with some preferred embodiments of the present invention, said at least one second control element cooperates with the movable element when the key is inserted in the keyway.

Furthermore, in accordance with some preferred embodiments of the present invention, said at least one second control element operates the movable element when the key is inserted in the keyway.

Furthermore, in accordance with some preferred embodiments of the present invention, said at least one second control element comprises at least one control pin located inside a bore extending from the keyway through the rotor, a portion of the bore continuing into the stator, and a spring for energizing said at least one control pin.

Furthermore, in accordance with some preferred embodiments of the present invention, said at least one control pin comprises a pin and a floating element.

Furthermore, in accordance with some preferred embodiments of the present invention, the floating element comprises a ball.

Furthermore, in accordance with some preferred embodiments of the present invention, a secondary spring operated pin assembly is located in the portion of the bore in the stator for cooperation with said at least one second control element.

Furthermore, in accordance with some preferred embodiments of the present invention, said at least one first control element or said at least one second control element comprises at least two telescopically engaged coaxial pins.

Furthermore, in accordance with some preferred embodiments of the present invention, an internal pin of said at least two telescopically engaged coaxial pins is provided for cooperation with a second movable element provided inside the movable element of the key.

Furthermore, in accordance with some preferred embodiments of the present invention, an internal pin of said at least two telescopically engaged coaxial pins is provided for operation of a second movable element provided inside the movable element of the key.

Furthermore, in accordance with some preferred embodiments of the present invention, said at least one first control element is energized to push the movable element when the key is inserted in the keyway towards said at least one second control element.

Furthermore, in accordance with some preferred embodiments of the present invention, said at least one second control element is energized to push the movable element when the key is inserted in the keyway towards said at least one first control element.

Furthermore, in accordance with some preferred embodiments of the present invention, there is provided a key for cooperation with a lock, the lock comprising a stator and a rotor with a keyway, having at least one first control element and at least one second control element for controlling rotation of the rotor, said at least one second control element provided in the lock opposite said at least one first control element with the keyway in between, the key comprising:

a penetrating portion for insertion in the keyway, the penetrating portion including at least one combination surface and at least one movable element that can be extended beyond at least one surface of the key, adding height to said at least one surface of the key and for cooperation with said at least one first control element, wherein an aperture is located on an opposite surface, behind the movable element for cooperation with said at least one second control element.

Furthermore, in accordance with some preferred embodiments of the present invention, the movable element comprises a floating element.

Furthermore, in accordance with some preferred embodiments of the present invention, an end of the floating element located in front of said at least one second control element, when the key is inserted in the keyway of the lock, has a surface with a depression.

Furthermore, in accordance with some preferred embodiments of the present invention, the movable element comprises a spring operated movable element.

Furthermore, in accordance with some preferred embodiments of the present invention, the movable element comprises an elastic element.

Furthermore, in accordance with some preferred embodiments of the present invention, said at least one movable element includes at least one second movable element planted in said at least one movable element for providing additional elevation surface.

Furthermore, in accordance with some preferred embodiments of the present invention, said at least one second movable element comprises a floating element.

Furthermore, in accordance with some preferred embodiments of the present invention, the second movable element comprises an elastic element.

Furthermore, in accordance with some preferred embodiments of the present invention, said at least one second movable element comprises at least one spring operated element.

Furthermore, in accordance with some preferred embodiments of the present invention, said at least one second movable element comprises more than one spring operated elements for providing more than one elevated surface.

Furthermore, in accordance with some preferred embodiments of the present invention, said at least one second movable element comprises movable elements that are located on opposite sides of said at least one first movable element.

Furthermore, in accordance with some preferred embodiments of the present invention, the key includes at least one pair of opposite directing movable elements.

### BRIEF DESCRIPTION OF THE FIGURES

The invention is described herein, by way of example only, with reference to the accompanying Figures, in which like components are designated by like reference numerals.

FIG. 1 is a sectional illustration of a PRIOR ART lock cylinder having a key inserted therein.

FIG. 2 is a sectional illustration of a lock cylinder having a key inserted therein and with the plug in an unlocked state in accordance with a preferred embodiment of the present invention.

FIG. 2A is a sectional illustration of a lock cylinder that bears resemblance to the lock shown in FIG. 2, with a modification, in accordance with another preferred embodiment of the present invention.

FIG. 3 is a sectional illustration of the lock cylinder of FIG. 2 having a key inserted therein (yet not in the proper position) and with the plug in a locked state in accordance with a preferred embodiment of the present invention.

FIG. 4 is a sectional illustration of a lock cylinder having a key inserted therein and with alternative shapes to the adjacent surfaces of a pusher pin assembly and of the bottom part of the movable pin element in accordance with an alternative preferred embodiment of the present invention.

FIG. 5 is a sectional illustration of a lock cylinder having a key inserted therein and with an additional secondary spring operated pin for providing enhanced rotor control in accordance with an alternative preferred embodiment of the present invention.

FIG. 6 is a sectional illustration of a lock cylinder having a key inserted therein with a spring operated secondary pin for providing enhanced rotor control in accordance with an alternative preferred embodiment of the present invention, where the spring is also used to activate both the pusher pin and the secondary pin.

FIG. 7 is a sectional illustration of a lock cylinder having a key inserted therein and provided with an auxiliary telescopic active pusher pin (with an additional internal pusher pin) in accordance with an alternative preferred embodiment of the present invention.

FIG. 8 is a sectional illustration of a lock cylinder having a key inserted therein and provided with a converted direction of operation, by providing pusher pins on the opposite side of the lock, and by providing stronger springs on that side, according to an alternative preferred embodiment of the present invention.

FIG. 9 is a sectional illustration of a key for a lock cylinder, where a movable pin element in the key shaft is modified to comprise an additional moving internal element, which is operated by the inner telescopic pusher pin, in accordance with an alternative preferred embodiment of the present invention.

FIG. 10A illustrates another alternative preferred embodiment of the present invention where movable pin element A further comprises a spring-mounted ball installed in the proximal and/or distal face of movable pin element A.

FIG. 10B illustrates an alternative exemplary arrangement of the embodiment of FIG. 10A.

FIG. 10C illustrates another alternative exemplary arrangement of the embodiment of FIG. 10A.

FIG. 11A illustrates another alternative preferred embodiment of the present invention where the ball is composed of an elastic material.

FIG. 11B illustrates the elastic ball under compression.

FIG. 11C illustrates a cross-sectional view of a key blank with two spring-operated protruding elements.

FIG. 12 illustrates a cross-sectional view of a key blank with two spring-operated protruding elements, each protruding element comprising additional elevation incorporated with the protruding element.

FIG. 13 illustrates a cross-sectional view of a key blank with two spring-operated protruding elements, each protruding element comprising additional elevation incorporated with the protruding element, where the additional elevation is achieved using elastic elements.

FIG. 14 illustrates a cross-sectional view of a key blank with two spring-operated protruding elements, with a bore provided on the opposite side of the key blank for cooperation with an additional control pin.

FIG. 15 illustrates a cross-sectional view of a key blank with two spring-operated protruding elements with several spring-activated elevations, with a bore provided on the opposite side of the key blank for cooperation with an additional control pin.

FIG. 16 illustrates a cross-sectional view of a key blank with two spring operated protruding elements, with independent bores provided behind each protruding element, with a separating wall between the bore and the protruding element, in accordance with another preferred embodiment of the present invention.

### DETAILED DESCRIPTION OF THE INVENTION

The present invention discloses improvements in locks and keys. It introduces improvements in the lock, which are aimed at providing additional rotor control mechanisms that cooperate with both sides of movable elements in the key simultaneously.

The present invention facilitates the rotation of a lock rotor by using not only the protruding section of a protruding element from the key blank, but also employing the opposite withdrawing side of the element or utilizing the void created under the protruding element when it protrudes outside the key, for operating additional control elements within the rotor. A main aspect of the present invention is the addition of at least one active pin operated behind the movable element of the key, in addition to the regular active pins.

The present invention provides an improved locking apparatus comprising a key with means for adjusting the height of the surface of the key shaft at one or more points, and a related lock, which is provided with additional enhanced rotor control means.

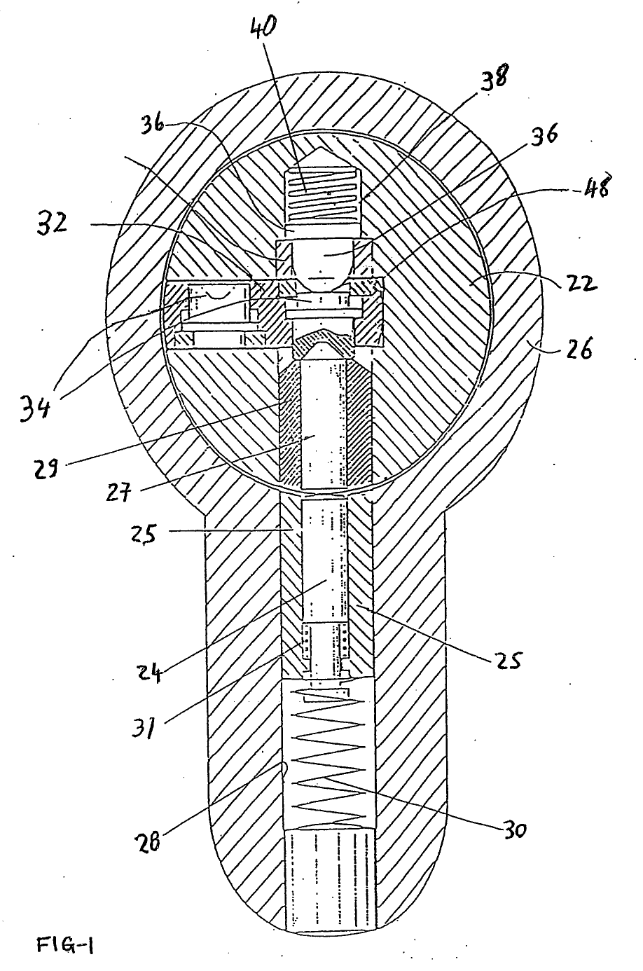

Additionally, the present invention introduces improvements to a locking apparatus mechanism disclosed in prior art U.S. Pat. No. 5,839,308 (FIG. 1), by transforming the pusher pin to become an additional active pin further to its role as a pusher pin, so that the pusher pin assembly has the added function of controlling rotation of the lock cylinder plug within the lock cylinder housing. This new control feature is in addition to the existing control of the rotation of the plug provided by the prior art first pin assembly and second pin assembly.

FIG. 1 illustrates a prior art (U.S. Pat. No. 5,839,308) lock cylinder having a key inserted therein. The lock generally comprises a cylinder plug (rotor) 22 rotate able within plug housing (stator) 26. First pin assemblies 27 and 29 and second pin assemblies 24 and 25 are provided within a bore 28 provided in the plug housing 26 and extending into the plug 22. In order to allow the lock to be operated the shear line between first pin assemblies 27, 29 and second pin assemblies 24, 25 will have to be positioned in the shear line defined between the rotor 22 and the stator 26 inside bore 28 (hereinafter—the “aligned position”).

Springs 30 and 31 pushes the pin assemblies away from the aligned position when there is no key inside the plug, or when a key with the wrong key combination is inserted. When the right key with the correct key combination is inserted in the plug the pin assemblies are align to the aligned position. The key 32 is provided with a movable pin element 34 that is displaced above the surface of the key shaft by spring-actuated pusher pin 36, which is retained in a bore 38 of plug 22. Pusher pin assembly 36 is actuated by spring 40, which is located at the end of pusher pin 38 that is distal to movable pin element 34 and exerts constant force on pusher pin assembly 38 in the direction of movable pin element 34.

When a proper key is inserted into the keyway in plug 22, such that movable pin element 34 is located in front of pusher pin 38, then spring 40 actuates pusher pin 38, which pushes pin element 34, causing pin element 34 to extend outwardly beyond the opposite combination surface of the key shaft into operative engagement with pin assemblies 27 and 29 such that the shear line defined between the first pin assemblies 27 and 29 and second pin assemblies 24 and 25 is positioned in the shear line defined between the rotor 22 and the stator 26 inside bore 28 then it is possible to rotate the plug of the lock by the key.

Insertion of a key without the moveable element 36 that adds height to the surface of the key will not allow the rotation of the lock because the shear line defined between the first pin assemblies 27 and 29 and second pin assemblies 24 and 25 will be positioned inside the rotor bore 28 instead of the proper position of the shear line that must be positioned between the rotor 22 and the stator 26 inside bore 28.

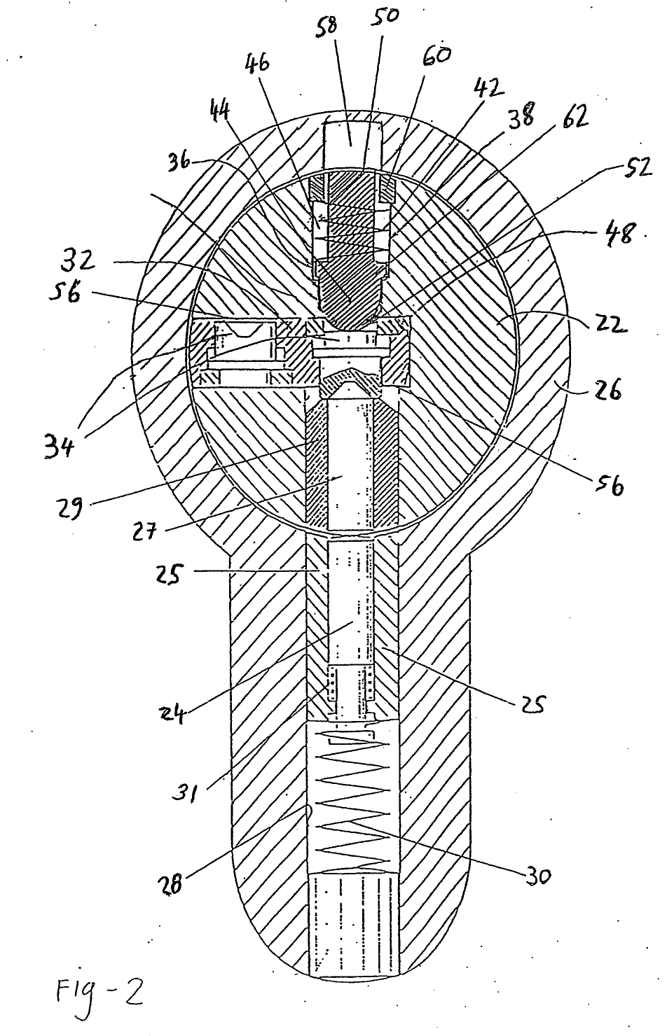

FIG. 2 is a sectional illustration of a lock cylinder having a key inserted therein and where the pusher pin assembly is adapted in accordance with a preferred embodiment of the present invention to control rotation of the lock cylinder plug within the lock cylinder housing. In the figure, the pusher pin is shown in the operating position that allows the rotation.

Spring 42 is located at the end of active pusher pin 44 that is distal to movable pin element 34 and exerts constant force on pusher pin 44 in the direction of movable pin element 34. Active pusher pin 44 is disposed in a pass-through bore 46, which is cut into plug 22 coaxially to, and on the opposite side of keyway 48 and of pin assemblies 24,25,27,29. Pass-through bore 46 extends through plug 22, from keyway 48 all the way to the external perimeter surface of plug 22. Active pusher pin 44 is longer than pass-through bore 46 such that when distal end 50 of pusher pin 44 is aligned with the external perimeter surface of plug 22 proximal end 52 of pusher pin 44 extends beyond the proximal end of pass-through bore 46 to push against the distal end of movable pin element 34 of the key. Proximal end 52 of pusher pin 44 primarily protrudes into the keyway, and when the key is inserted into the keyway it pushes it against spring 42 back into its bore. In order to make sure that the proximal end 52 of pin 44 slides conveniently over the penetrating key it is recommended to provide it with an inclination (for example, slanted or convex/concave).

In summary, spring 42 pushes against pusher pin 44, causing proximal end 52 of pusher pin 44 to push against distal end of movable pin element 34, causing proximal end 54 of movable pin element 34 to extend beyond key combination surface 56 to push out pin assemblies 24,25,27,29 into bore 28 against springs 30 and 31 allowing plug 22 be turned.

Housing bore 58 is provided in housing 26 coaxially opposite distal end 50 of pusher pin 44. Optional retaining ring 60 plugs pass-through bore 46, thereby retaining pusher pin 44 and spring 42 while allowing pass-through movement of distal end 50 of pusher pin 44 into housing bore 58.

Optional shoulder 62 is located distal to proximal end 52 of pusher pin 44 and retains pusher pin 44 within pass-through bore 46 while allowing pass-through movement of proximal end 52 of pusher pin 44 into keyway 48 up to a predetermined stopping point that does not extend beyond the opposite side of the keyway.

This stopping point of proximal end 52 of pusher pin 44 serves the purpose that, when the key shaft is inserted into keyway 48, the key shaft pushes against proximal end 52 of pusher pin 44, thereby pushing pusher pin 44 back up into pass-through bore 46. This means that when a key with incorrect key combination is inserted in the keyway it causes the pusher pin 44 to be inserted into bore 58 and jams the lock, preventing its operation.

It should be noted that spring 42 is preferably stronger than springs 30 and 31 of pin assemblies 24,25,27,29 so as to favor active pusher pin 44 pushing out the pin assemblies rather than the opposite.

When the key shaft is inserted into keyway 48, until movable pin element 34 aligns with active pusher pin 44, key combination surface 56 blocks active pusher pin 44 from pulling its distal end 50 down out of housing bore 58, thereby preventing rotation of plug 22. Only when movable pin element 34 has reached alignment with active pusher pin 44, can active pusher pin 44 push down on movable pin element 34, thereby pulling distal end 50 of pusher pin 44 out of housing bore 58, than enabling rotation of plug 22.

It should be clear to one skilled in the art that any key that does not include such movable pin element 34 or a void beneath the movable pin will not enable distal end 50 of pusher pin 44 to leave housing bore 58, thus such a key would not be able to operate the lock. Furthermore one skilled in the art will appreciate that this prevents use of unauthorized keys with added height at predetermined points on the key shaft to open the lock.

Effectively, the present invention makes use of both ends of the floating movable pin 34 of the key in the provision of a more secured lock mechanism that is superior to the one described by Eizen.

In order to emphasize the difference and uniqueness of the locking apparatus of the present invention, it should be noted that, while in prior art only one end of movable pin element 34 was exploited for locking and releasing plug 22, in the present invention each end of movable pin element 34 is part of a separate mechanism for locking and releasing plug 22. In other words, in the present invention, while extension of proximal end 54 of movable pin element 34 beyond key combination surface 56 is used to push out second pin assembly 24 and thereby release plug 22 from being locked, at the same time, this causes the distal end of movable pin element 34 to enter key shaft 56, thereby pulling distal end 50 of pusher pin 44 out of housing bore 58, thereby releasing plug 22 from being locked to housing 26.

The present invention is not limited only to a key with a movable pin element as described by Eizen, and other embodiments will be described herein with reference to other drawings.

Generally speaking, the present invention makes use of a key with dynamic surface topography and utilizes not only one side but both opposing sides of the dynamic surface topography points of the key and at the same time, for operating not just one mechanism of the lock, but two (or even more).

FIG. 2A is a sectional illustration of a lock cylinder that bears resemblance to the lock shown in FIG. 2, with a modification, in accordance with another preferred embodiment of the present invention. The operation principle is similar to the one of the lock shown in FIG. 2. Here, instead of an integral pusher pin 44 in FIG. 2, a pusher pin 36 is similar to the one shown in the prior art lock of FIG. 1, with the addition of a tail 39, and a floating ball 41, that cooperates with bore 58 in the stator.

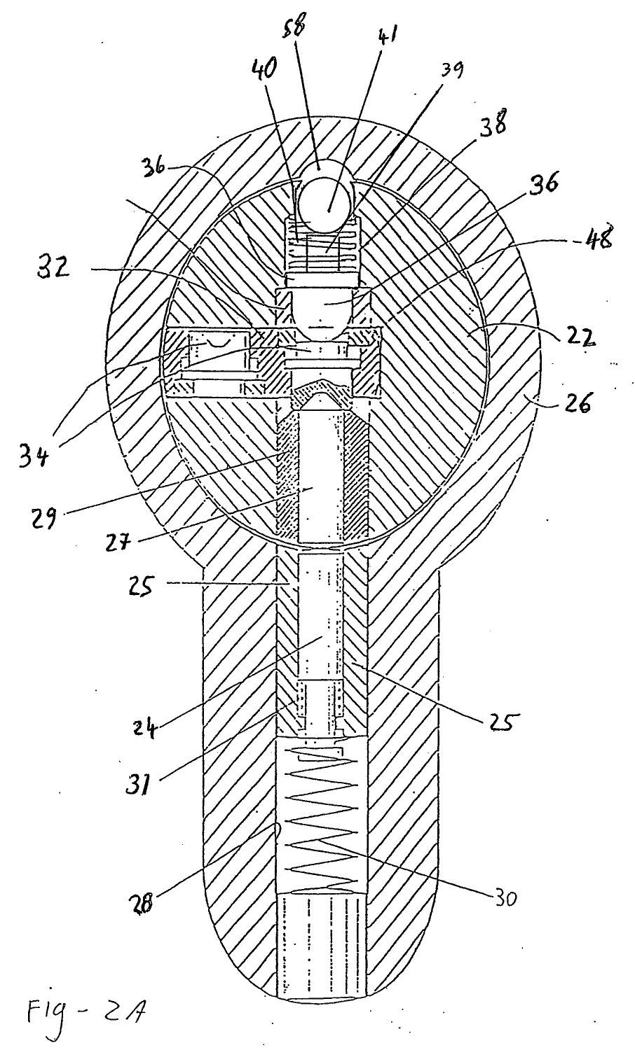

FIG. 3 is a sectional illustration of the lock cylinder of FIG. 2 with the difference that FIG. 3 shows the condition of the components during key insertion before key shaft 56 has reached the point where movable pin element 34 aligns with active pusher pin 44. In the condition shown in FIG. 3, distal end 50 of pusher pin 44 extends into housing bore 58, preventing rotation of plug 22. This will also be the condition of pusher pin 44 if the key used does not comprise a moveable pin element at all or comprise moveable element, which is not in the proper location or not in the proper structure.

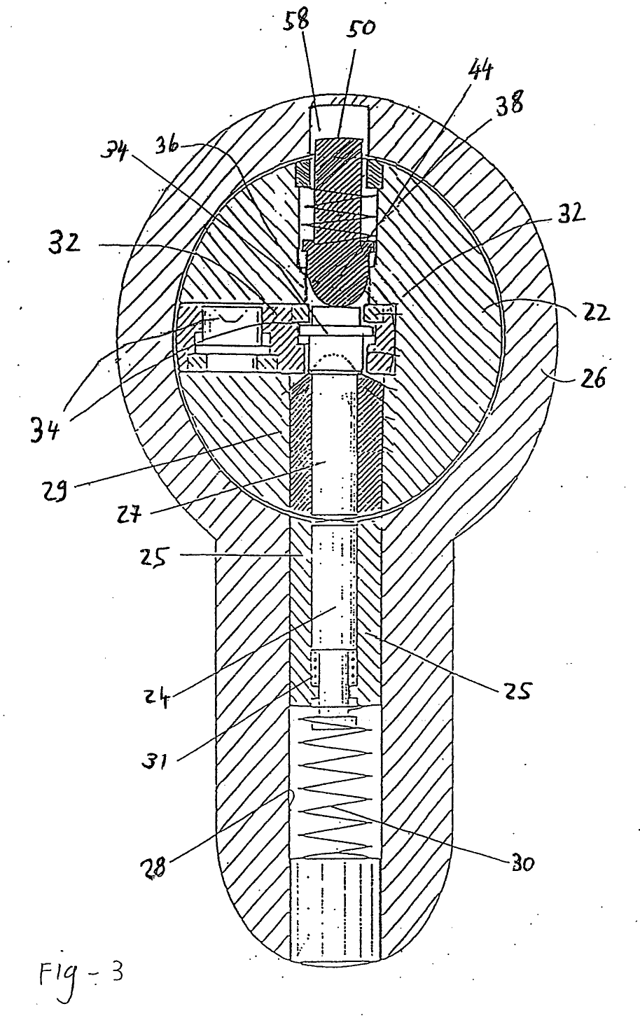

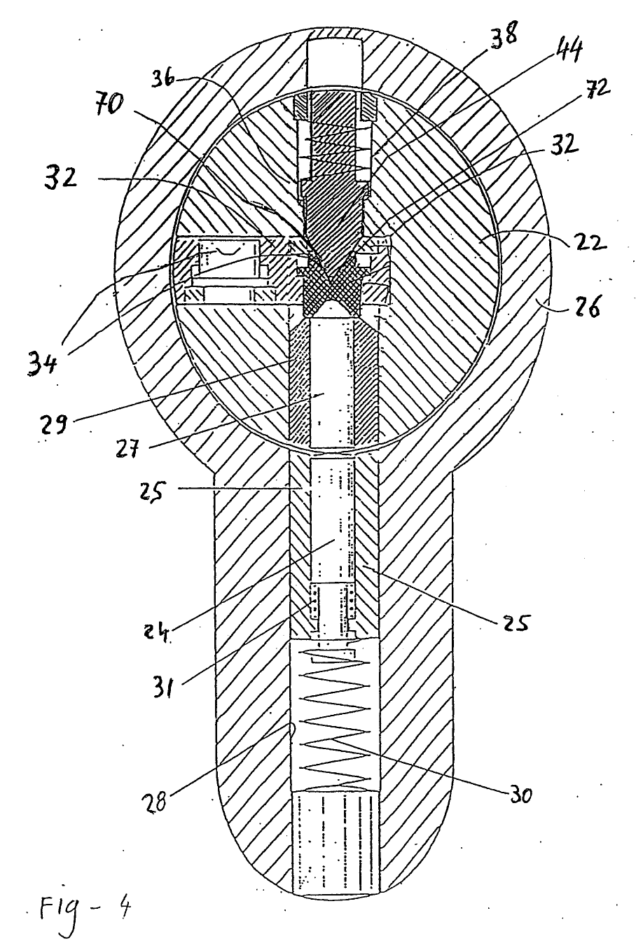

FIG. 4 illustrates an alternative preferred embodiment of the present invention wherein the distal end of movable pin element 34 includes socket 70, which is shaped to receive matching shaped proximal end 72 of pusher pin 44. This alternative preferred embodiment is similar to that described for the preferred embodiment of FIG. 2 with the difference that pusher pin 44 is longer, its shaped tip made to fit socket 70. The significance of this lies in that the elongation of the pusher pin prevents operation of the lock with keys that has other means for adding height to the surface of the key, except for the correct key as disclosed herein, due to the deep penetration of the active pusher pin into the corresponding socket of the movable pin.

FIG. 5 illustrates another alternative preferred embodiment of the present invention. In this embodiment, housing bore 58 retains a second pusher pin 76 and a second pusher spring 78. Second pusher spring 78 is operative to provide additional force coaxially with the force applied by spring 42 to activate pusher pin 44 towards movable pin element 34 at such time that movable pin element 34 is aligned with pusher pin 44. In addition, when movable pin element 34 is so aligned, second pusher spring 78 is operative to move second pusher pin 76 towards distal end 50 such that a shear line is defined between the facing surfaces of second pusher pin 76 and pusher pin 44. This embodiment provides a solution to prevent unauthorized opening attempts of the lock while using keys with a dent that is deeper than the exact length of protrusion of the active pusher pin, when it sinks into the rotor of the lock. In other words, only a key with the exact depth of dent can operate this lock.

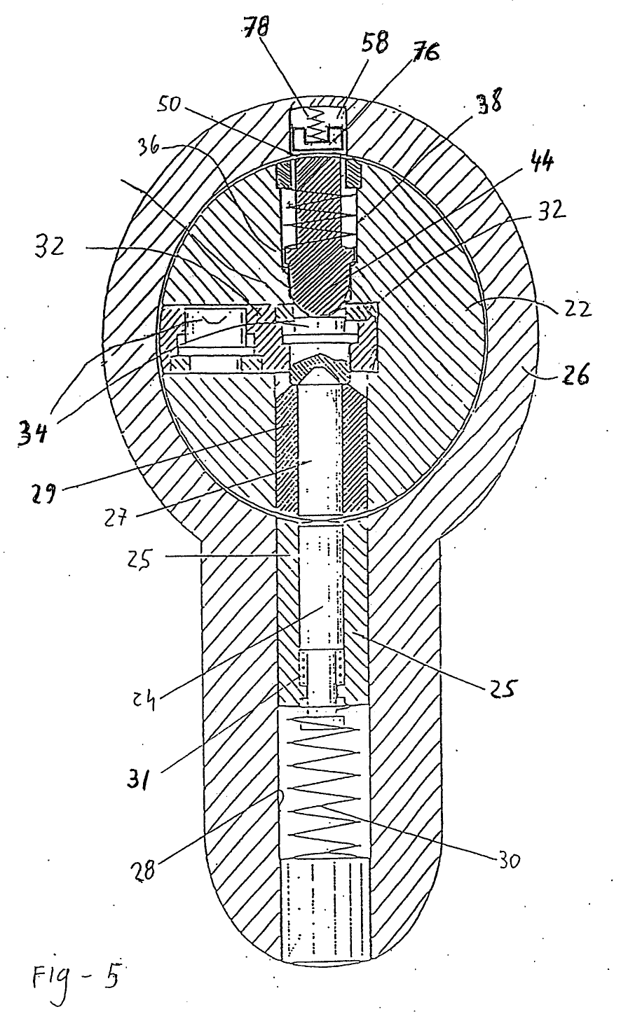

FIG. 6 illustrates another alternative preferred embodiment of the present invention wherein second pusher spring 78 is of sufficient strength to eliminate the need for spring 42 (see FIG. 5). It will be noted that secondary pusher spring 78 is therefore stronger than spring 37 of pin assembly 24 so as to favor active pusher pin 44 pushing out pin assembly 24 rather than the opposite. Pin assemblies 33 and 35 and spring 37 are used to control the rotation of the plug 22, it should be noted that obviously it is possible to use telescopic pin assemblies (24,25,27,29) as described in the previous figs.

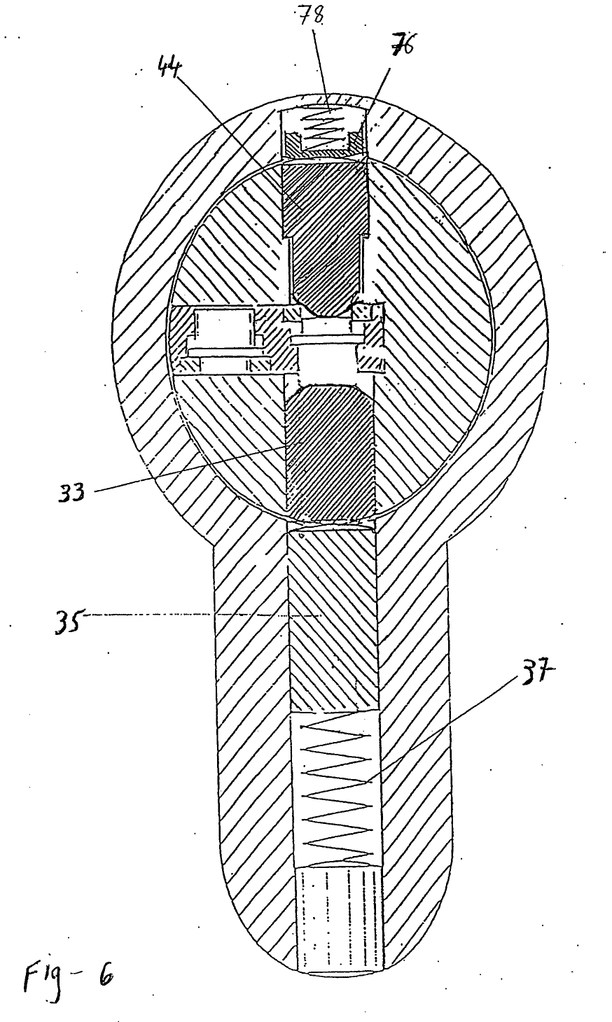

FIG. 7 illustrates another alternative preferred embodiment of the present invention further comprising an auxiliary pusher pin assembly 80 that applies force by spring 78 to both active pusher pin 44 and to active pusher pin 82 (which is inserted telescopically in pin 44) by auxiliary pusher pin 86 (which is telescopically inserted in pin 80) and spring 84.

extension of auxiliary active pusher pin 82 can be to a different length than modified active pusher pin 44, according to the height of the mating distal end surface of movable pin element 34, defined by edge 33 provided over the movable pin element 34. pusher spring 78 and auxiliary pusher pin assembly 80 apply force on the perimeter of active pusher 82.

active pusher pin 82 thereby makes it possible to further vary the depth and shape of the socket 37 formed in the beneath surface of movable pin element 34 inside the proximal ends of modified pusher pin 44, which in turn increases the number of variations possible in the beneath surface of movable pin element 34. This in turn further enhances the security of the locking apparatus.

it should be noted that obviously it is possible to use active pusher pin 44 also as housing for spring operated internal active pusher pin 82 and to give up on both auxiliary pusher pin assemblies 80 and 86 and springs 78 and 84 in similar way as described in FIG. 2 with the addition of spring operated internal active pusher pin 82 inside the body of active pusher pin 44 that is used also as housing for the spring operated internal active pusher pin 82.

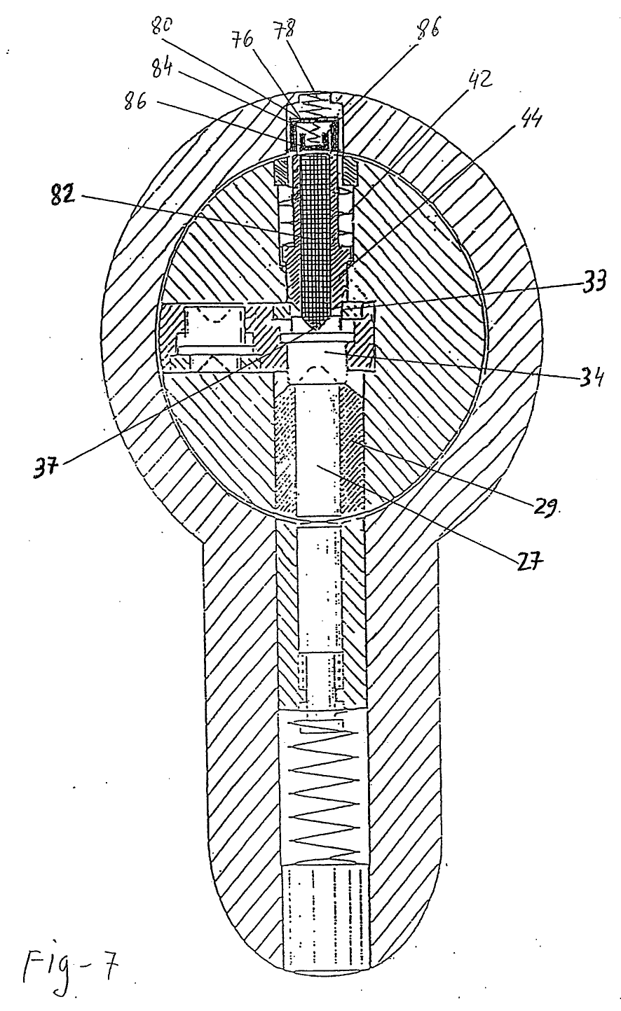

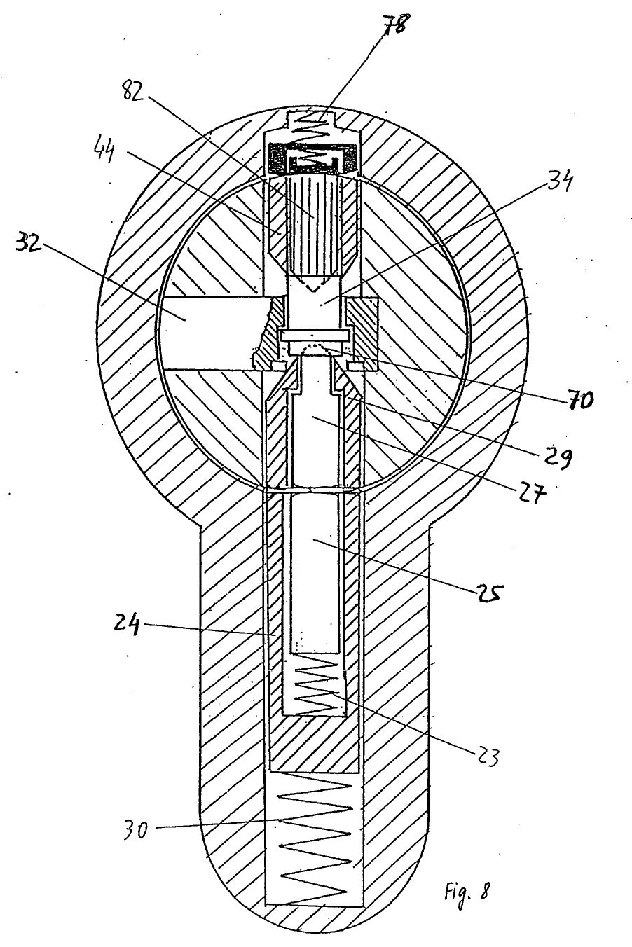

FIG. 8 illustrates another alternative preferred embodiment of the present invention similar to that of the embodiment illustrated in FIG. 7 but the direction of operation is reversed. In this embodiment force is applied by telescopic pin assembly 24 (and its internal telescopic pin 25), which are now active pusher pins. These pins raise the movable element 34 of the key and operate additional telescopic pins 44, 82, which are shorter than the length between the keyway and the external perimeter of the rotor. This embodiment allows greater key variety and combinations in order to increase the security level of the lock and key.

FIG. 9 illustrates another alternative preferred embodiment of the present invention where movable pin element 34 in key shaft 32 is modified to comprise a stepped bore 90 retaining an additional inner movable pin 92 by the use of shoulder 94 in the bore and matching bulge 93. Movable pin 92 is movable coaxially within movable pin element 34, thereby comprising an additional moving element. When movable pin element 34 is correctly aligned, depending on the strength of the opposing springs applied to it, inner movable pin 92 adds to the displacement of the proximal end of movable pin element 34 above the surface of key shaft 32 or reduces the displacement of the distal end of movable pin element 34 into the surface of key shaft 32. The inner movable pin 92 is activated by internal telescopic pusher pin 82, so that it allows operation of the opposite inner telescopic pin 27 (within pin 29, FIG. 8).

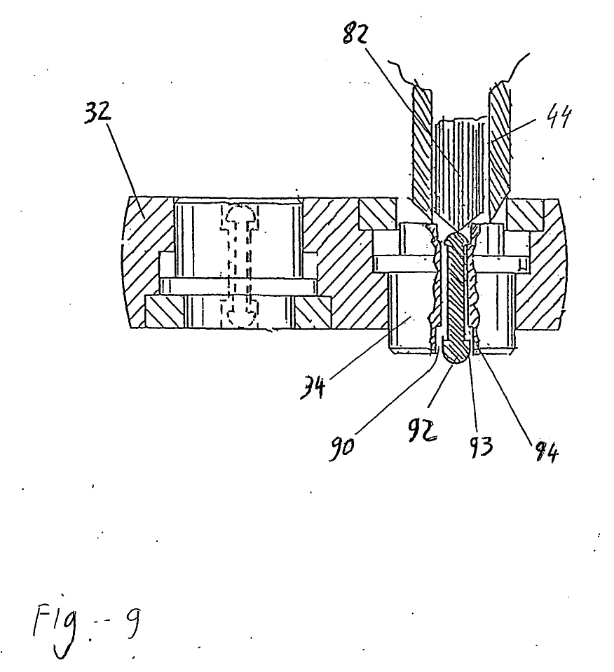

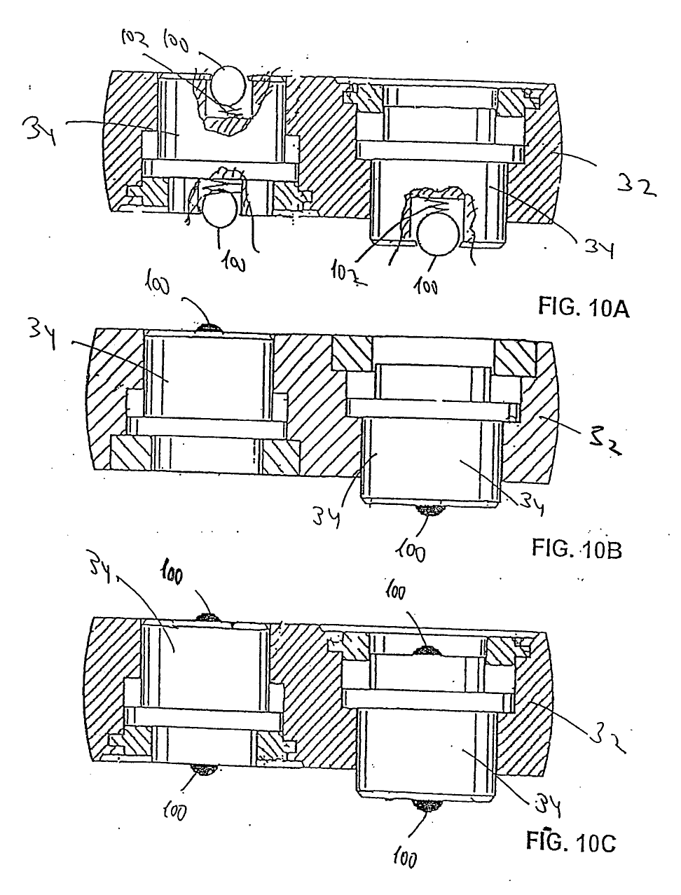

FIG. 10A illustrates another alternative preferred embodiment of the present invention where movable pin element 34 in key shaft 32 is modified to comprise a spring-mounted ball 100 (pressed out by spring 102) inside bore 104 that is adds height to a surface of movable pin element 34. In the movable pin element 34 on the right-hand side of the figure, a first spring-mounted ball is installed in the proximal face of movable pin element 34, thereby adding to the displacement of the proximal face of movable pin element 34 above the surface of key shaft 32.

In the movable pin element 34 on the left-hand side of the figure, in addition to the first spring-mounted ball installed in the proximal face of movable pin element 34, a second spring-mounted ball is installed in the distal face, thereby providing topographic diversity to the key.

FIG. 10B illustrates another alternative preferred embodiment of the present invention with a first spring-mounted ball 100 is installed in the proximal face of a movable pin element 34 (right side) and a second spring-mounted ball 100 installed in the distal face of a movable pin element 34 (left side).

FIG. 10C illustrates another alternative preferred embodiment of the present invention with a spring-mounted balls 100 installed in both the proximal and distal faces of movable pin elements 34.

The keys shown in FIGS. 10A-10C exhibit different operation possibilities to add height to the movable elements in different sizes and directions. In some preferred embodiments of the present invention the movable elements and their corresponding additional elevations can be made to operate in all, directions simultaneously and can be designed to operate different mechanisms to facilitate the rotation of the lock.

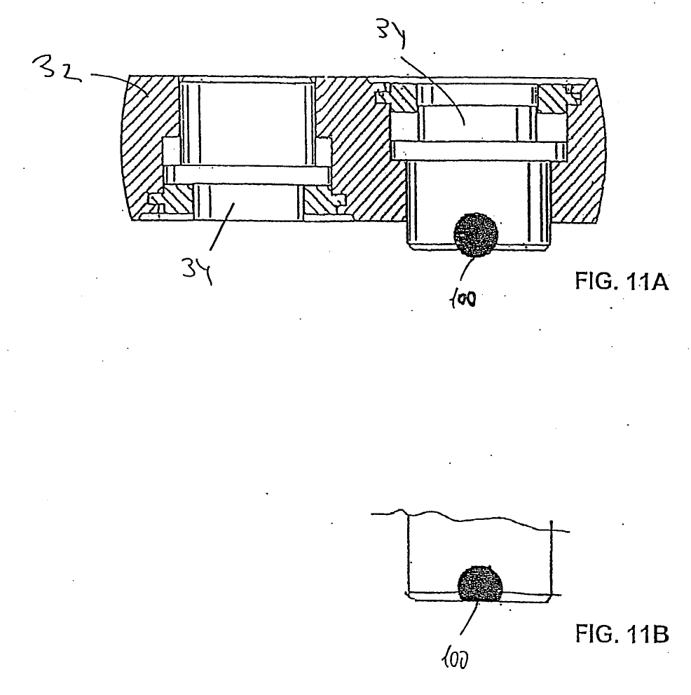

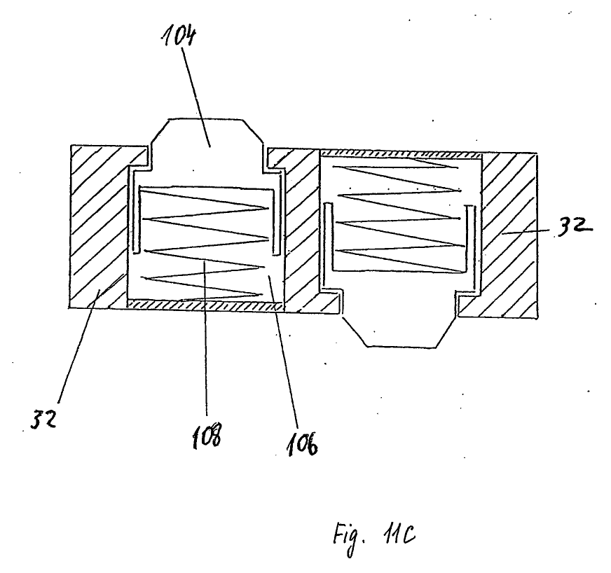

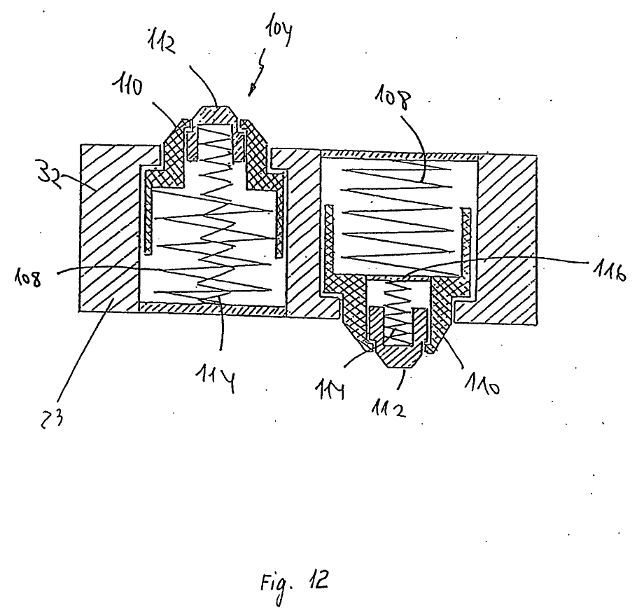

FIG. 11A illustrates another alternative preferred embodiment of the present invention where the ball 100 is composed of an elastic material (such as rubber, an elastic polymer or other such material).

FIG. 11B illustrates how the elastic ball 100, when force is applied to it, collapses into the supporting face of movable pin element 34. The operation of the elastic balls on the movable elements is similar to the operation described with reference to previous figures, with the addition of flexibility, which is added due to the flexibility of the ball. The elasticity of the ball replaces the need for a spring.

FIG. 11c is prior art illustrates a cross-sectional view of a key blank with two spring-operated protruding elements. Similarly to the key depicted in FIG. 11A and FIG. 11B when pressure is applied on the protruding element 104, which is forced to protrude out of the bore 106 it resides in, on the key shaft 32, by spring 108, the protruding element retracts and levels with the key shaft.

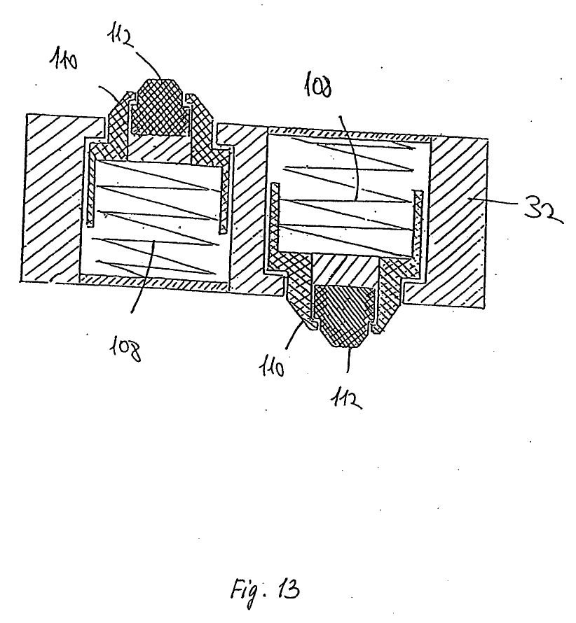

FIG. 12 illustrates a cross-sectional view of a key blank with two spring-operated protruding elements, each protruding element comprising additional elevation incorporated with the protruding element. Here the protruding elements comprise two coaxially mounted parts 110, 112, each energized by a spring (108, 114 respectively) for added elevations. The springs of the protruding element on the left-hand side are, both, supported by the bottom wall of the bore, while another embodiment is suggested on the right hand-side of the drawing, where the spring 114 supported on a separate wall 116 within part 110.

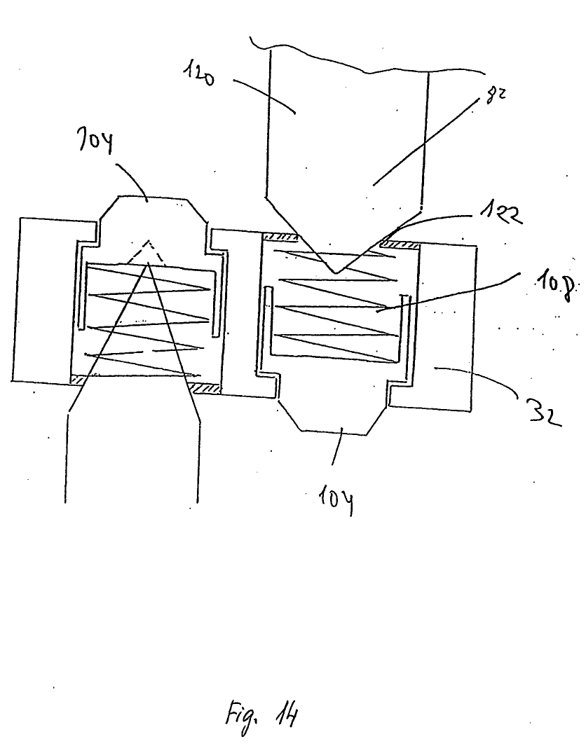

FIG. 13 illustrates a cross-sectional view of a key blank with two spring-operated protruding elements, each protruding element comprising additional elevation incorporated with the protruding element, where the additional elevation is achieved using a protruding part 112 made from an elastic material.

FIG. 14 illustrates a cross-sectional view of a key blank with two spring-operated protruding elements (similar to the key blank shown in FIG. 11C), with a bore provided on the opposite side of the key blank for cooperation with an additional control pin. The bore 122, is designed to allow control pin 120 to penetrate it up to a desired depth, which is determined by the maximal width of the bore and the tapering shape of the pin. The penetrating pin may be designed to penetrate the void in the key as much as touching the bottom of the movable element, or even penetrating into its body.

Alternatively, the key blank may be provided with a dent instead of a bore, into which the control pin may be inserted. This embodiment facilitates utilizing both opposite sides of the key blank for cooperation with control mechanisms.

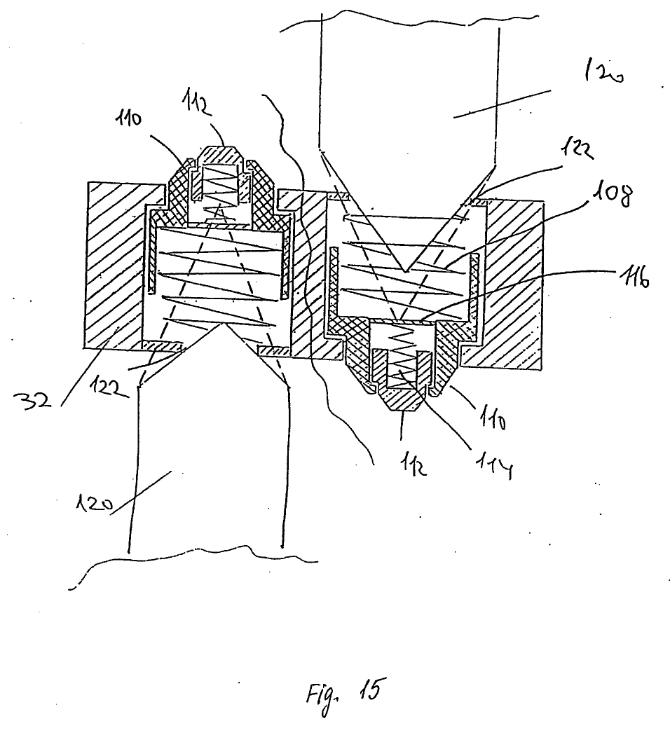

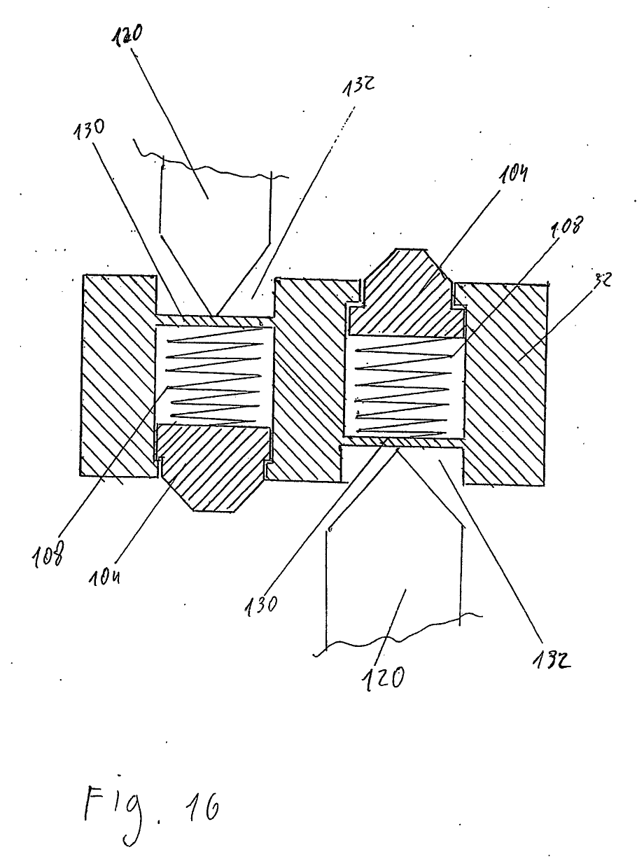

FIG. 15 illustrates a cross-sectional view of a key blank with two spring-operated protruding elements with several spring-activated elevations, with a bore provided on the opposite side of the key blank for cooperation with an additional control pin. The key presented in this drawing is in fact a combination of the features depicted in FIG. 12 with the features depicted in FIG. 14. This key also allows utilizing both opposite sides of the key blank for cooperation with control mechanisms. The bore 122, is designed to allow control pin 120 to penetrate it up to a desired depth, which is determined by the maximal width of the bore and the tapering shape of the pin. The penetrating pin may be designed to penetrate the void in the key as much as touching the bottom of the movable element, or even penetrating into its body;

FIG. 16 illustrates a cross-sectional view of a key blank with two spring (108) operated protruding elements 104, with independent bores 132 provided behind each protruding element, with a separating wall 130 between the bore and the protruding element, in accordance with another preferred embodiment of the present invention. The wall may act as a stopper for the control element 120. The depth of the bore determines how deep the control element may penetrate into the bore.

Alternatively, in another preferred embodiment of the present invention, the spring-operated protruding elements shown in FIG. 16 may be replaced by elastic elements (see, for example, additional element 112 in FIG. 13).

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A lock and a cooperating key combination, the lock comprising a stator and a rotor with a keyway, the key comprising a penetrating portion for insertion in the keyway, the penetrating portion including at least one combination surface and at least one movable element that can be extended beyond at least one surface of the key, adding height to said at least one surface of the key and for cooperation with at least one first control element for controlling rotation of the rotor,
wherein at least one second control element for controlling the rotation of the rotor is provided in the lock opposite said at least one first control element with the keyway in between, said at least one second control element adapted to cooperate with an aperture located on the opposite surface of the key, behind the movable element.

2. The combination of claim 1, wherein said at least one second control element cooperates with the movable element when the key is inserted in the keyway.

3. The combination of claim 2, wherein said at least one second control element operates the movable element when the key is inserted in the keyway.

4. A lock for cooperation with a key comprising a penetrating portion for insertion in keyway of the lock, the penetrating portion including at least one combination surface and at least one movable element that can be extended beyond at least one surface of the key, adding height to the said at least one surface of the key and for cooperation with at least one first control element for controlling rotation of the rotor, the lock comprising:
a stator and a rotor with a keyway, wherein at least one second control element for controlling the rotation of the rotor is provided in the lock opposite said at least one first control element with the keyway in between, said at least one second control element adapted to cooperate with an aperture located on the opposite surface of the key, behind the movable element.

5. The lock of claim 4, wherein said at least one second control element cooperates with the movable element when the key is inserted in the keyway.

6. The lock of claim 5, wherein said at least one second control element operates the movable element when the key is inserted in the keyway.

7. The lock of claim 4, wherein said at least one second control element comprises at least one control pin located inside a bore extending from the keyway through the rotor, a portion of the bore continuing into the stator, and a spring for energizing said at least one control pin.

8. The lock of claim 7, wherein said at least one control pin comprises a pin and a floating element.

9. The lock of claim 8, wherein the floating element comprises a ball.

10. The lock of claim 7, wherein a secondary spring operated pin assembly is located in the portion of the bore in the stator for cooperation with said at least one second control element.

11. The lock of claim 10, wherein said at least one first control element or said at least one second control element comprises at least two telescopically engaged coaxial pins.

12. The lock of claim 11, wherein an internal pin of said at least two telescopically engaged coaxial pins is provided for cooperation with a second movable element provided inside the movable element of the key.

13. The lock of claim 11, wherein an internal pin of said at least two telescopically engaged coaxial pins is provided for operation of a second movable element provided inside the movable element of the key.

14. The lock of claim 4, wherein said at least one first control element is energized to push the movable element when the key is inserted in the keyway towards said at least one second control element.

15. The lock of claim 4, wherein said at least one second control element is energized to push the movable element when the key is inserted in the keyway towards said at least one first control element.

16. A key for cooperation with a lock, the lock comprising a stator and a rotor with a keyway, having at least one first control element and at least one second control element for controlling rotation of the rotor, said at least one second control element provided in the lock opposite said at least one first control element with the keyway in between, the key comprising:
a penetrating portion for insertion in the keyway, the penetrating portion including at least one combination surface and at least one movable element that can be extended beyond at least one surface of the key, adding height to said at least one surface of the key and for cooperation with said at least one first control element, wherein an aperture is located on an opposite surface, behind the movable element for cooperation with said at least one second control element.

17. The key of claim 16, wherein the movable element comprises a floating element.

18. The key of claim 17, wherein an end of the floating element located in front of said at least one second control element, when the key is inserted in the keyway of the lock, has a surface with a depression.

19. The key of claim 16, wherein the movable element comprises a spring operated movable element.

20. The key of claim 16, wherein the movable element comprises an elastic element.

21. The key of claim 16, wherein said at least one movable element includes at least one second movable element planted in said at least one movable element for providing additional elevation surface.

22. The key of claim 21, wherein said at least one second movable element comprises a floating element.

23. The key of claim 21, wherein the second movable element comprises an elastic element.

24. The key of claim 21, wherein said at least one second movable element comprises at least one spring operated element.

25. The key of claim 24, wherein said at least one second movable element comprises more than one spring operated elements for providing more than one elevated surface.

26. The key of claim 21, wherein said at least one second movable element comprises movable elements that are located on opposite sides of said at least one first movable element.

27. The key of claim 16, wherein the key includes at least one pair of opposite directing movable elements.
